(19) United States
(12) Patent Application Publication
(10) Pub. No.: US 2008/0103977 A1
(43) Pub. Date: May 1, 2008

(54) DIGITAL RIGHTS MANAGEMENT FOR DISTRIBUTED DEVICES

(75) Inventors: Moe Khosravy, Kirkland, WA (US); Lev Novik, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/672,793

(22) Filed: Feb. 8, 2007

Related U.S. Application Data
(60) Provisional application No. 60/863,577, filed on Oct. 31, 2006.

(51) Int. Cl. G06Q 99/00

(52) U.S. Cl. 705/59

(57) ABSTRACT

DRM protected content is shared in a peer-to-peer device context. In various embodiments, systems are enabled for peer-to-peer digital rights management (DRM) content roaming via revocation and synchronization. Local license revocation and remote license creation can facilitate P2P DRM content roam using license share counts. Derivative share count licenses, or other derivative licenses, are generated on the target device, reducing the local license commensurately.

### CROSS-REFERENCE TO RELATED APPLICATIONS

This application claims priority to U.S. Provisional Patent Application Ser. No. 60/863,577 filed Oct. 31, 2006, entitled “DIGITAL RIGHTS MANAGEMENT FOR DISTRIBUTED DEVICES”. The entirety of this application is incorporated herein by reference.

### TECHNICAL FIELD

The subject disclosure relates to digital rights management (DRM) in a peer-to-peer networked computing environment.

### BACKGROUND

Today, when a user possesses multiple devices, such as a personal computer (PC), phone, MP3 player, laptop, etc. and wishes to play some content, such as a song or a video, protected by digital rights management (DRM) from each of those devices, the user must involve a central licensing authority (CLA) to issue or validate a license for rendering the content. The CLA may be the content owner or an independent third party that intervenes before DRM content can be successfully roamed from device to device. For instance, where a user wishes to transfer a song from a home PC to a work PC, today, a CLA will interface with the work PC to issue or validate an appropriate license for playing the content.

This is illustrated in FIG. 1, where a user has a PC 110, gaming console 120, portable media player (PMP) 130 and mobile phone 140. As shown by the dotted arrows, prior to being able to act with respect to DRM content on any of PC 110, console 120, PMP 130 and phone 140, CLA 100 intervenes to obtain or validate a license for performing such actions. For instance, prior to being able to play a DRM protected song, CLA 100 would have to communicate with each of PC 110, console 120, PMP 130 and phone 140 according to the particular DRM system implemented for the song.

In addition, rich consumer media segment is currently divided into content that is protected using DRM software and clear content media (i.e., content that is free to distribute/share/roam with anyone). While there are numerous DRM technologies, DRM solutions for easily and securely transferring DRM content from one device to another in a pure peer-to-peer (P2P) fashion simply do not exist largely due to fear over unfettered re-distribution of DRM protected content. If the license server or designated authority 100 is down, a user cannot transfer a protected piece of content from one endpoint (PC, media device, service, etc.) to another without significantly affecting the lifetime of the license.

Thus, there are no systems that meet the needs of a user to share content, such as a song, across multiple P2P networked devices. For instance, there is no way, without involving a CLA, to share content directly between devices, while appropriately limiting the scope of such sharing. Additional detail about these and other deficiencies in the state of sharing DRM protected content in a peer-to-peer environment may be apparent from the description of the various embodiments of the invention that follows.

### SUMMARY

In consideration of the lack of solutions for sharing DRM protected content in a peer-to-peer device context, various systems are provided for peer-to-peer digital rights management (DRM) content roaming via revocation and synchronization. Based on a local license for DRM protected content at a first device, the invention enables the DRM protected content to be shared with a second device in a peer-to-peer device context while also synchronizing license data sufficient to construct a remote license that governs interaction with the DRM protected content on the second device. The rights of the remote license can be derived from rights of the local license, and the rights of the local license can be reduced commensurate with the scope of rights defined by the remote license.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

The systems and methods for sharing DRM protected content among peer-to-peer devices are further described with reference to the accompanying drawings in which:

FIG. 1 illustrates the involvement of a central licensing authority (CLA) 100 according to a technique described in the background;

FIG. 2A illustrates a high level block diagram of the peer-to-peer license sharing system of the invention;

FIG. 2B illustrates exemplary non-limiting user interface component(s) for use in connection with sync transfer of DRM protected content in accordance with the invention;

FIGS. 3A, 3B, 3C, 3D, 3E and 3F are block diagrams illustrating exemplary sharing of DRM protected content in a P2P environment in accordance with the invention;

FIG. 4 illustrates an exemplary non-limiting flow diagram showing exemplary sharing of DRM protected content in a P2P environment in accordance with the invention;

FIGS. 5A, 5B, 5C, 5D and 5E are block diagrams illustrating exemplary sharing of DRM protected content in a P2P environment in accordance with the invention;

FIG. 6 illustrates a general flow diagram for determining whether rights are available to generate a derivative license in accordance with the invention;

FIG. 7 illustrates a exemplary non-limiting flow diagram for determining whether rights are available to generate a derivative license according to a share count enforced by licenses in accordance with the invention;

FIG. 8A illustrates various aspects of derivative licensing across P2P devices in accordance with the invention;

FIG. 8B illustrates various aspects of licensing derivative content across P2P devices in accordance with the invention;

FIG. 9 is a block diagram representing an exemplary non-limiting networked environment in which the present invention may be implemented; and

FIG. 10 is a block diagram representing an exemplary non-limiting computing system or operating environment in which the present invention may be implemented.

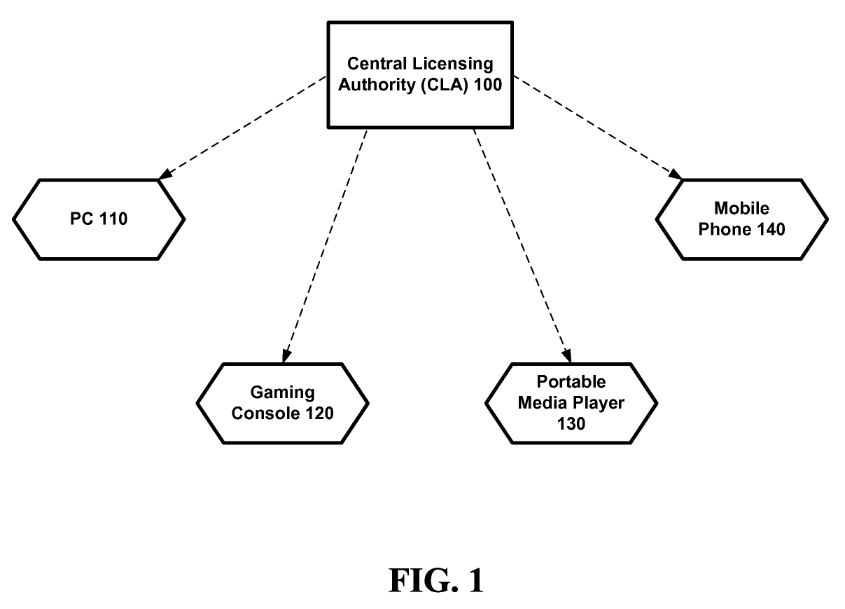

### DETAILED DESCRIPTION

### Overview

As discussed in the background, there are no DRM solutions for easily and securely transferring DRM content from one device to another in a pure P2P fashion. For instance, there is no way, without involving a CLA, to share content directly between devices, while appropriately limiting the scope of such sharing according to a DRM licensing regime.

In consideration of such need, the P2P DRM model of the invention is lightweight enough to accommodate any DRM implementation, and in various non-limiting embodiments described in more detail below, even relatively simple device DRM implementations can be accommodated because the system respects DRM policies set by the content creator. The invention operates irrespective of whether the P2P environment is a single master sync environment or a multi-master sync environment.

### Syncing of DRM Protected Content Among Peer-to-Peer Devices

In various non-limiting embodiments described below, the invention enables any one or more of the following scenarios, separately or simultaneously: (1) Content has a license allowing it to be shared with more than 1 device (a single user), (2) Content has a license allowing it to be shared with more than 1 device (many users), (3) Content is licensed for exactly one endpoint (locked to 1 device) and (4) Content can only be played back from a single device, but streamed to others (TV, other device, etc.).

In an exemplary non-limiting embodiment, the invention implements local license revocation and remote creation to facilitate P2P DRM using license share counts. For instance, with any DRM technology, licenses can be granted (created) on a device, which give the device certain rights with respect to the content. This may involve initial consultation with a central licensing authority, e.g., the content owner, or the device itself may act as a licensing authority for content over which the device has domain, or ownership, independent of the rights of others. Such rights given to the device with respect to the content may include playback count, share count, read/write capabilities, etc.

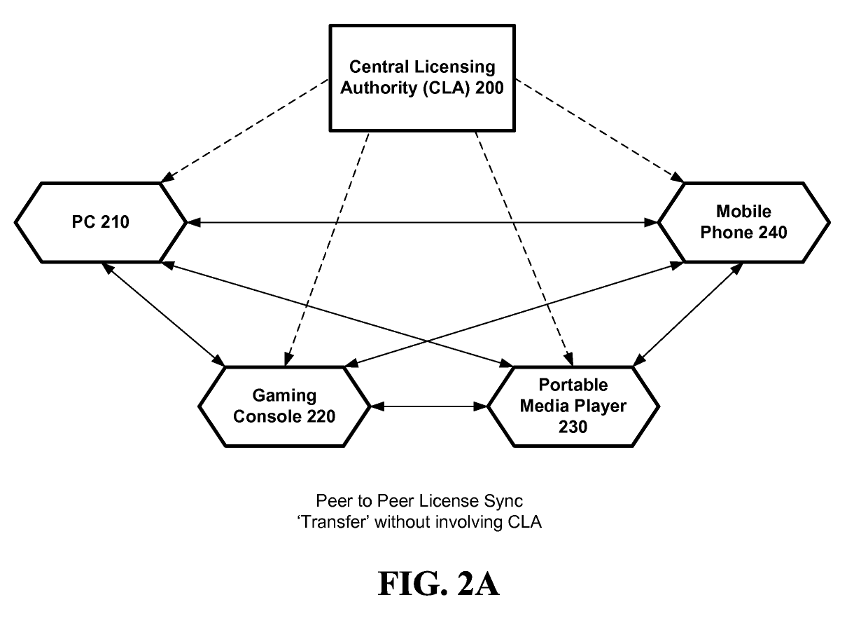

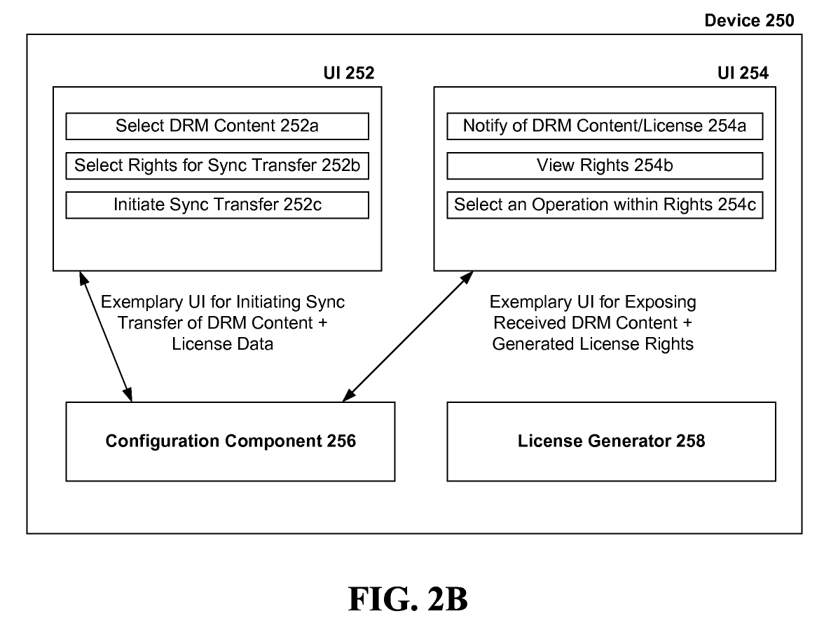

As shown in FIG. 2A, a system is provided where a user's Home PC 210, gaming console 220, portable media player 230 and mobile phone 240 are devices in accordance with the invention that can synchronize/share DRM content. Each device is provisioned with the capabilities for creating a license as well as revoking a license. While an initial license may come into the device ecosystem from a central licensing authority 200, the invention further provides the ability to share the DRM protected content directly from device to device as part of synchronization operations (any sync protocol can be used).

In accordance with the invention, such basic functionality (and any optional functionality) would be implemented for a DRM system in each device. In addition, each device may include one or more interfaces for interacting with sync transfer of DRM protected content in accordance with the invention. For instance, FIG. 2B illustrates a device 250, which may be any of devices 210, 220, 230, 240, etc. of FIG. 2A, that includes exemplary non-limiting user interface components 252 and/or 254 for displaying various options for performing sync transfer of DRM protected content to another device and/or receiving DRM protected content from another device in accordance with the various embodiments of peer-to-peer license sharing of the invention.

For instance, exemplary UI 252 may be for initiating sync transfer of DRM protected content plus license data in accordance with the invention. Via UI 252, a user may select DRM protected content for sync transfer to another device via control 252a, select rights to embed in license data in connection with the sync transfer to another device via control 252b, initiate a sync transfer operation via control 252c, etc. Additional controls may be included in exemplary UI 252 as well in order to support options for a particular license transfer scenario, such as any of the various scenarios described herein. In addition, while depicted as two user interface components 252 and 254 in FIG. 2B, such user interface components can be integrated, or further subdivided, etc.

Similarly, device 250 may include exemplary UI 254 for exposing DRM protected content received from another device and associated license rights generated from license data received from the other device. Exemplary non-limiting controls for UI 254 may include a notification control 254a for notifying the user that DRM protected content has been received or is otherwise available on device 250, a control 254b for viewing available rights for interacting with the DRM protected content received by device 250, a control 254c for initiating an operation within the rights of device 250 to perform on the DRM protected content per the license generated by device 250 via license generator 258 based on the license data received from the sync transferring device.

Moreover, as shown in FIG. 2B, each device 250 in accordance with the invention may include a configuration component 256 for configuring any scenario-based options as described in the various exemplary, non-limiting embodiments of the invention. For instance, configuration component 260 can be used to enables any one or more of the following scenarios for device 250, separately or to the extent possible, simultaneously: (1) content has a license allowing it to be shared with more than 1 device (a single user), (2) content has a license allowing it to be shared with more than 1 device (many users), (3) content is licensed for exactly one endpoint (locked to 1 device) and (4) content can only be played back from a single device, but streamed to others (TV, other device, etc.).

Additional detail for the lightweight P2P DRM model of the invention is presented by way of the following exemplary song-sharing scenario.

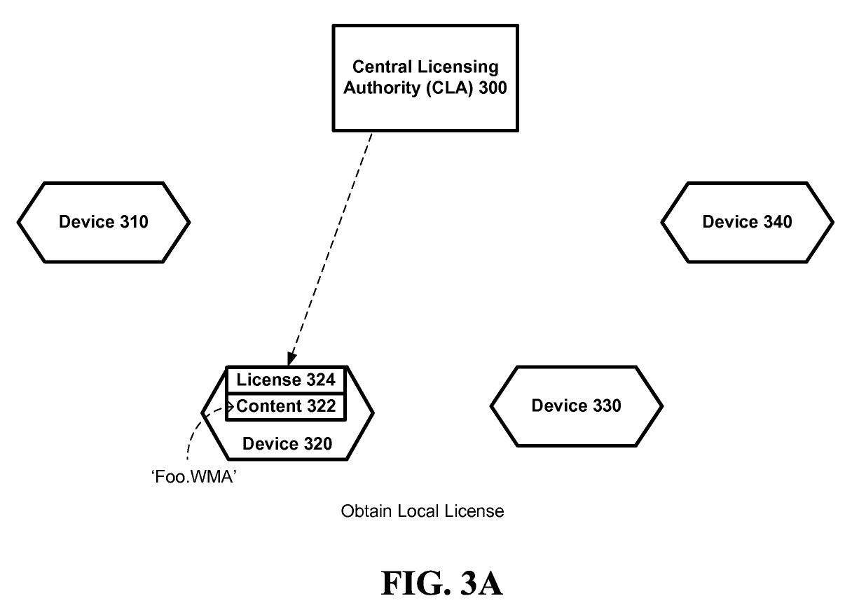

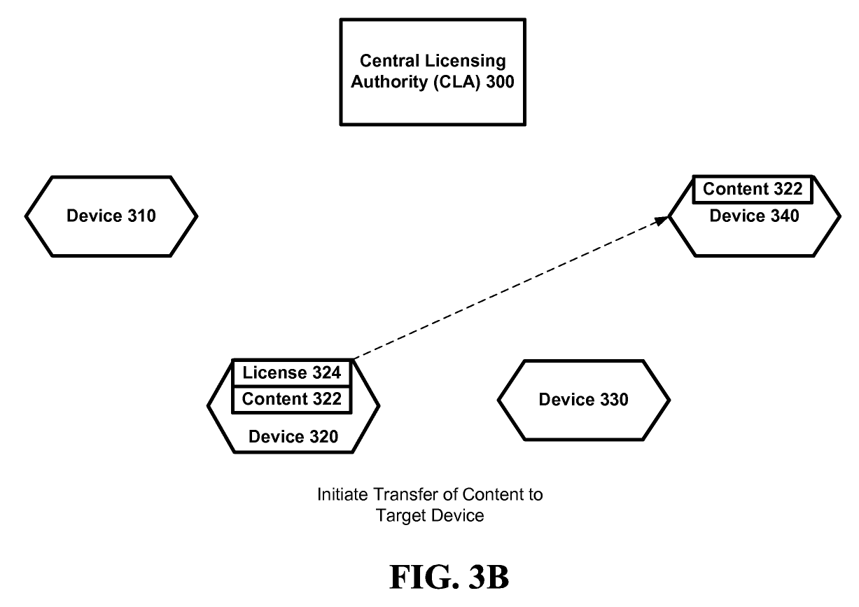

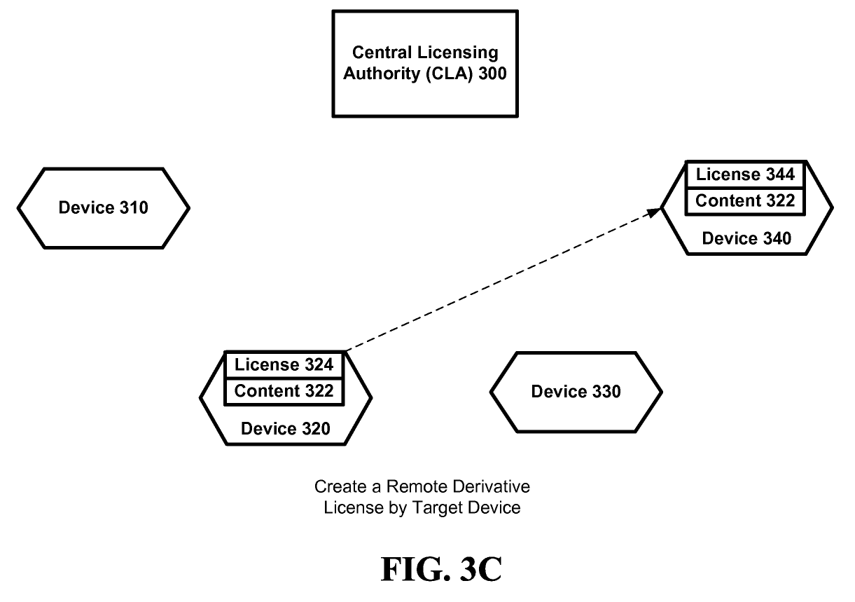

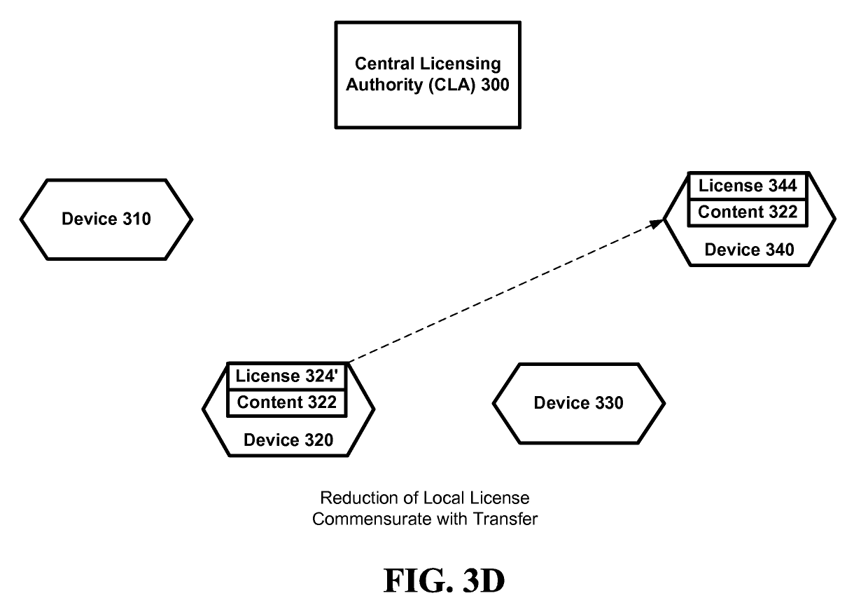

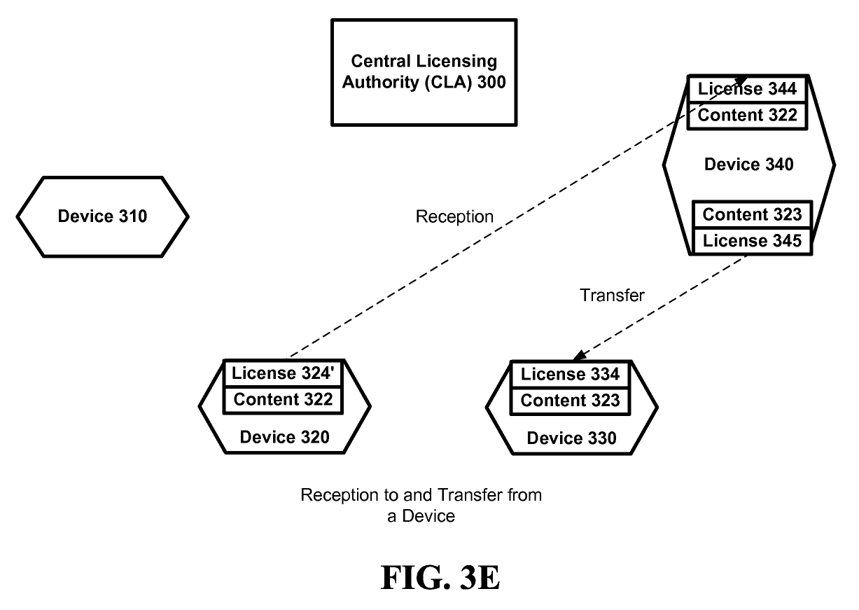

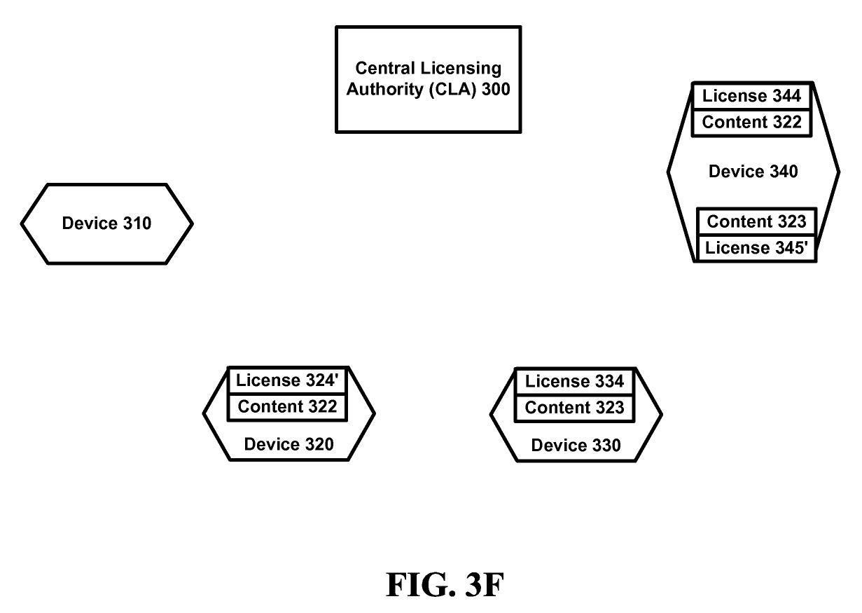

As shown in FIG. 3A, a set of devices 310, 320, 330 and 340 interoperate according to the P2P license sharing methods of the invention, whereby each device includes the ability to create and revoke local licenses. Initially, a user's device 310 contains a protected song 322, e.g., “Foo.WMA,” that has a license 324. In one implementation, license 324 indicates that song 322 can be transferred with only X other endpoints (i.e., devices) before the license is invalidated. For simplicity, only one piece of content is illustrated in various examples herein, though for the avoidance of doubt, the invention can apply for any number of pieces and kinds of DRM protected content. Also, the license may be originated on device 310 or received initially from a CLA 300.

Then, as shown in FIG. 3B, the user connects device 340, e.g., the user plugs in the user's phone, and initiates synchronization to device 320 according to any synchronization protocol to exchange a copy of the content 322 to device 340 along with any raw license data that might be needed for generating a license by device 340.

Then, as shown in FIG. 3C, the transferee device, here device 340, generates license 344, which is a derivative license from license 324. additionally, at FIG. 3D, depending upon the scope of transfer involved in generating the remote license 344, license 324 is reduced or eliminated (revoked) to license 324′.

Next, FIG. 3E illustrates that a device 340, or any device of the P2P networked environment, may both receive content 322 from a device 320 and transfer content 323 to device 330 in accordance with synchronization processes implemented for DRM protected content in accordance with the invention. Content 323 is synchronized to device 330 and license data based at least partly on associated license 345 of device 340 is also transmitted to the device 330, based upon which license 334 is constructed for interacting with content 323 on device 330. Finally, similar to FIG. 3D, FIG. 3F builds on FIG. 3E to illustrate that the rights of license 345 of device 340 may be reduced commensurate with the gain in rights of license 334 on device 330 to form license 345′ on device 340.

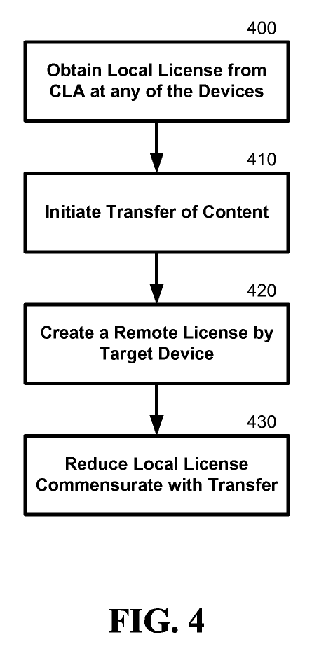

FIG. 4 is an exemplary non-limiting flow diagram for describing the transfer of DRM protected content according to the invention. At 400, a local license is obtained at one of the devices, e.g., from a CLA. Then, at 410, a user initiates transfer of content from one device to another via a synchronization protocol (DRM protected content can be exchanged between devices as “changes” between devices to sync songs). Then, at 420, a remote license is created by the target device that received the DRM protected content via the synchronization procedure. Then, at 430, the local license is reduced (or eliminated) commensurate with the transfer of rights to ensure that license rights are not ever expanding after transferring rights.

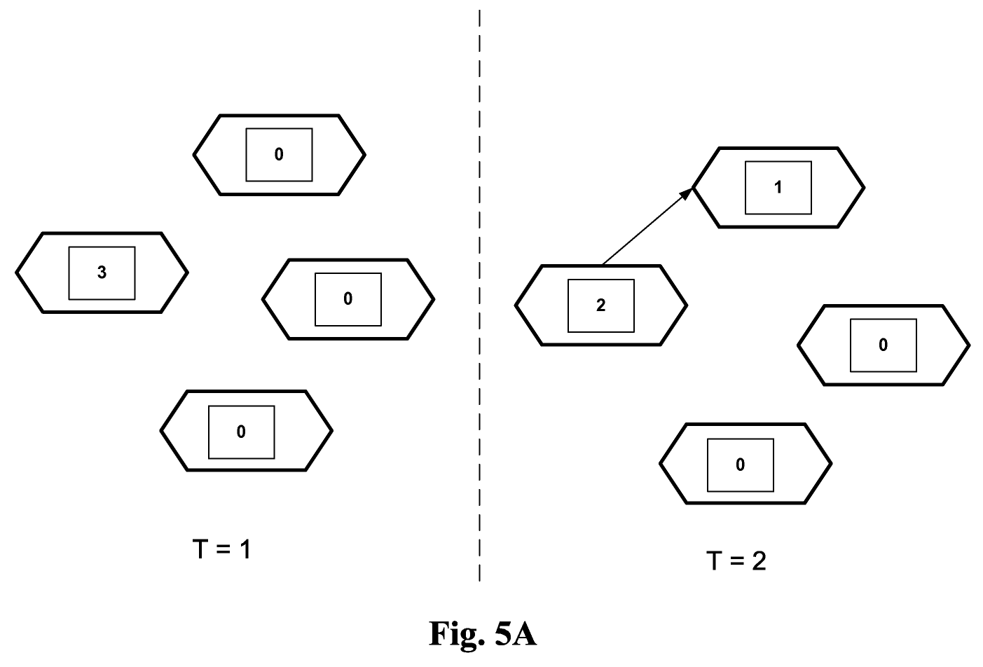

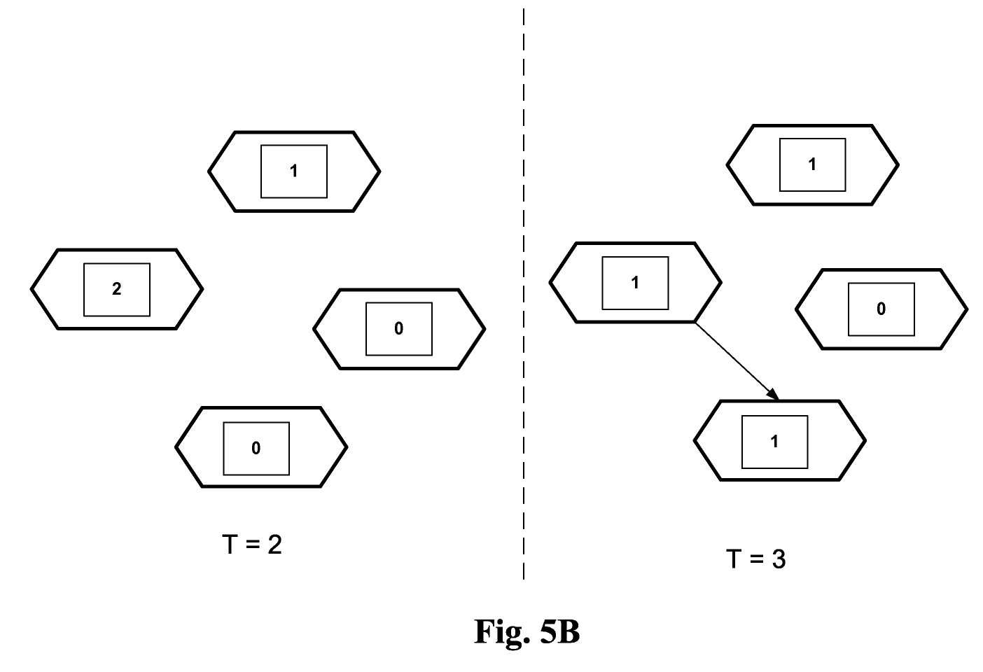

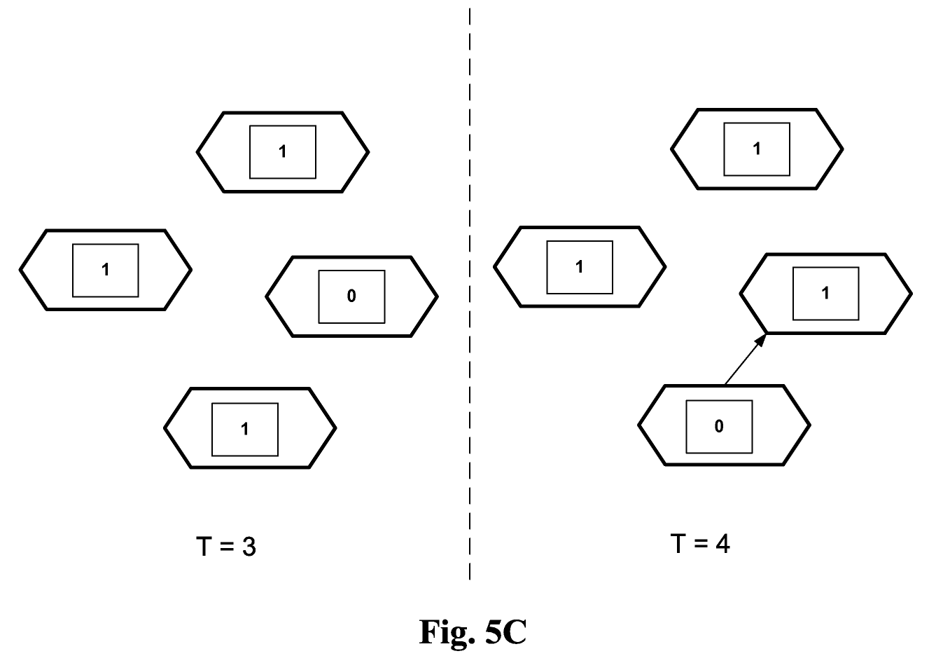

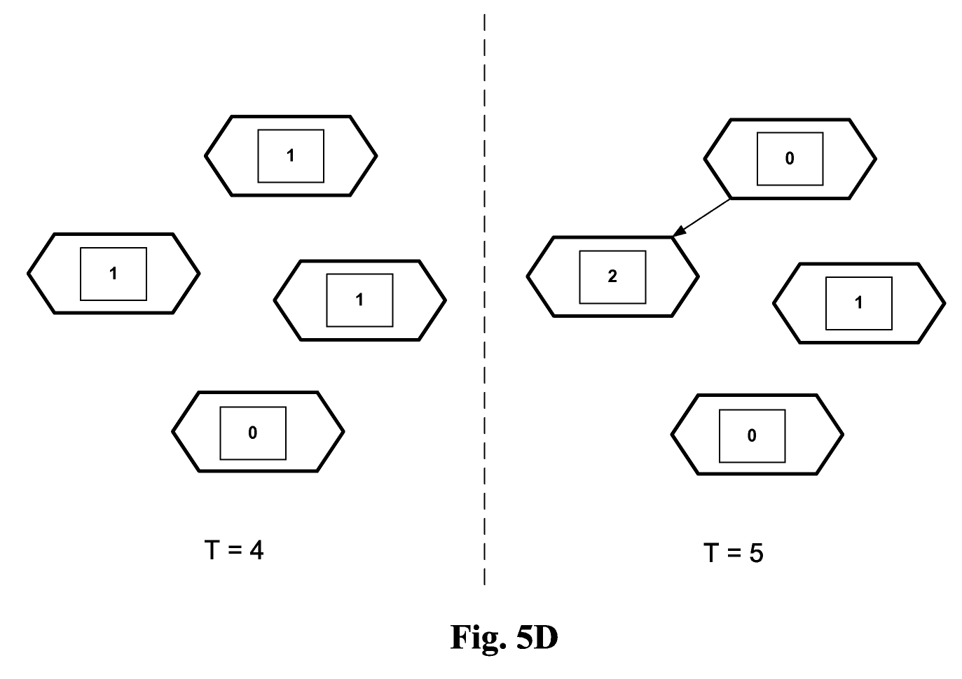

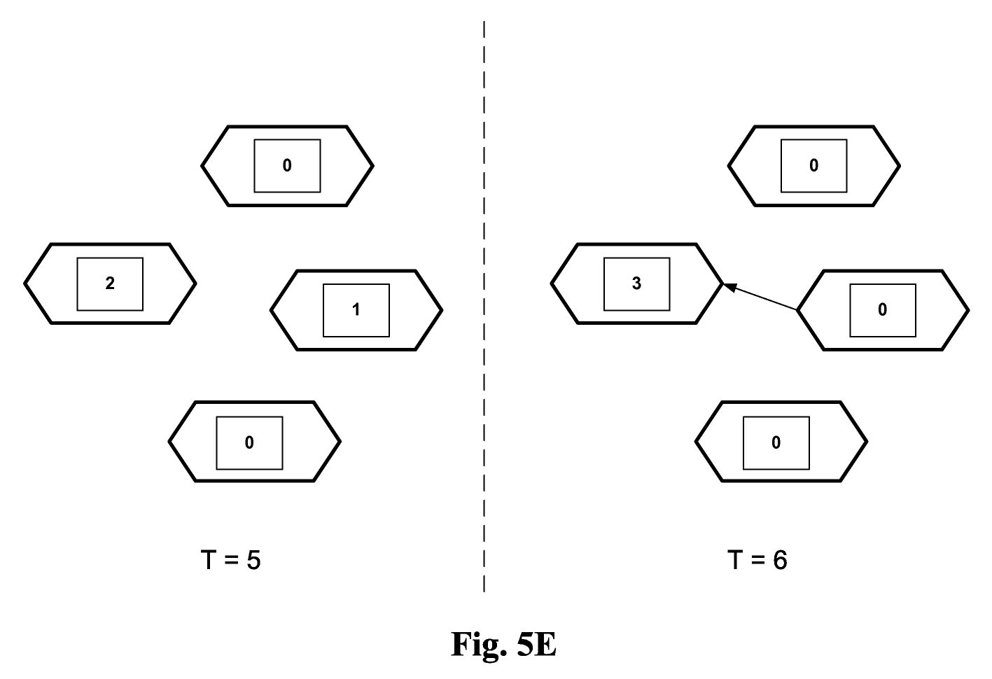

In various non-limiting embodiments of the invention, a content share count comprises part of the license associated with the content. The concept is illustrated in FIGS. 5A to 5E. In FIG. 5A, at time t=1, there are four devices that are set up with synchronization capabilities with one another. At time t=1, one of the devices has a piece (or multiple pieces) of DRM protected content for which the user is allowed to share the content with other devices three other times. The other devices have a license share count indicator of zero, indicated a license is non-existent, has been revoked, or that will be revoked. At time t=2 on the right side, a user has initiated a sync operation that transfers a copy of the DRM protected content to a second device as shown by the arrow. In accordance with the invention, a license is then created on the second device with a share count of one (1). Optionally, any transferee device, i.e., the second device in this example, may sign the license.

The share count of the license on the first device is then reduced to two (2) shares. FIG. 5B then shows that another copy is transferred to a third device, creating a license on the third device and reducing the share count of the license of the first device again by one. FIG. 5C illustrates the further scenario where the third device transfers a copy of the DRM protected content to a fourth device, creating a license on the fourth device with a share count of 1. The license on the third device is revoked because there are limits on the sharing of the DRM protected content to more than 3 devices.

FIGS. 5D and 5E then illustrate the recapture of license rights by the first device. FIG. 5D shows the recapture of the license rights granted to the second device. FIG. 5E shows the recapture of the license rights granted to the third device, returning the share count for the license associated with the DRM protected content back to the original three limit.

In an alternate embodiment of the invention, recapture is not allowed so that in the embodiments of FIGS. 5A to 5E, the DRM protected content can only be shared three times, and thus, the scenarios of FIGS. 5C, 5D and 5E would be disallowed.

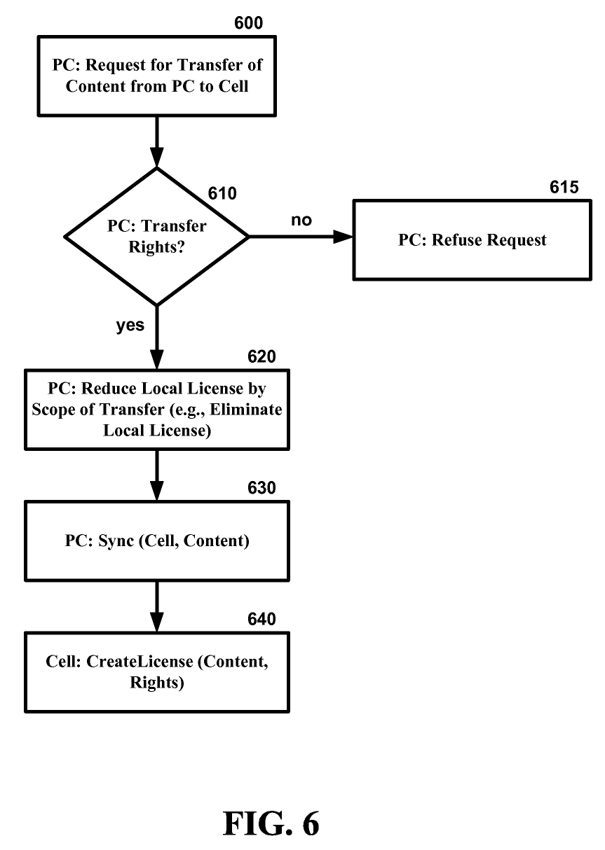

This is illustrated more generally in FIG. 6 illustrating an exemplary non-limiting flow diagram for implementing the enforcement of licensing rights across P2P devices in accordance with the invention. For illustrative purposes only, the flow diagram illustrates the transfer of DRM protected content from a PC to a Cell phone and the generation of a derivative license by the Cell. At 600, the PC receives a request for transfer of content from the PC to the Cell phone via any synchronization protocol for synchronizing content of the PC to the Cell. At 610, first it is determined whether the PC has the rights to transfer the content to the Cell. If not, the request is refused at 615. If rights exist for the transfer, then at 620, the PC reduces its local license by the scope of the transfer. If the reduction eliminates the remaining rights, the local license is revoked. At 630, the content is sent to the Cell as changes according to any synchronization protocol. Then, at 640, the Cell generates a license for the content commensurate with the scope of rights granted.

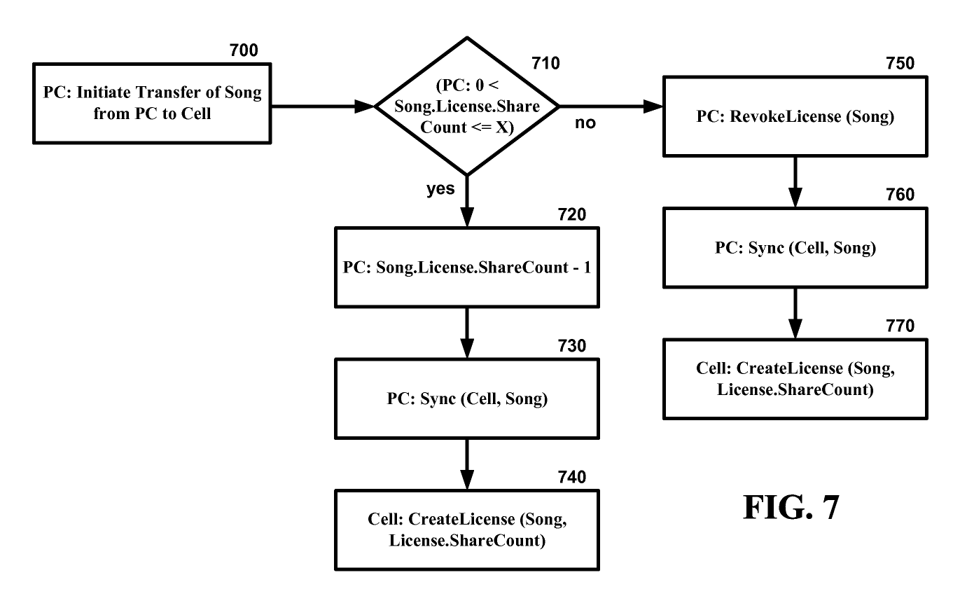

This is illustrated more specifically for the above-described share count derivative licensing techniques in FIG. 7. At 700, the PC initiates transfer of DRM protected content from the PC to the Cell. At 710, it is determined whether after a sharing operation, whether the share count will be non-zero and less than or equal to a maximum share count. If so, then the PC reduces the share count of the local license by one at 720, syncs the DRM protected content to the Cell from the PC and then at 740, the Cell creates the license with a single share count. If, at 710, it is determined that it is there will be no further share counts in the local license after transfer, then at 750, the PC revokes its local license for the song. Then, steps 760 and 770 mirror steps 730 and 740, respectively. If the share count is already zero, then no transfer can occur for lack of rights.

FIG. 7 may operate according to the following exemplary non-limiting pseudo-code to enforce a share count in accordance with the invention.

if (PC: 0 < Song.License.ShareCount <= X)
{

| | |
|---|---|
| PC: Song.License.ShareCount−−; | //Decrement the share count |
| PC->Sync(Cell, Song); | //Transfer the song (no license yet) |

| | |
|---|---|
| Cell->CreateLicense(Song, | //Create a remote license |
| License.ShareCount); | |
| } | |

else //Song.License.ShareCount = 0, so perform revocation to facilitate
sharing
{

| | |
|---|---|
| PC->RevokeLicense(Song); | //Revoke the local PC's license |
| PC->Sync(Cell, Song); | //Transfer the song |

| | |
|---|---|
| Cell->CreateLicense(Song, | //Create the remote license |
| License.ShareCount); | |
| } | |

If the user later takes the second device to another device, such as the user's work PC, the variable X of the above would dictate whether or not the license would be revoked from the second device to allow content flow onto the other device.

In short, unlike other DRM systems, content can still be transferred in the absence of a central licensing authority or requiring mandatory Direct License Acquisition (DLA) from the content provider for remote endpoints. While the license's share count is greater than the number of endpoints, content is transferred via the normal sync pipeline. When mandatory, the license for the local endpoint is revoked to create a duplicate license for the remote endpoint.

Share count is but one non-limiting example wherein a derivative license is generated on the transferee device by reducing the share count of a local license when creating the derivative license on the target device. However, as illustrated by FIG. 6A, any derivative licensing technique is supported in accordance with the invention. Whenever a first device transfers part or all of a license L to another device, the first device sends over any data that may be required to create a remote derivative license DL by the target device.

Derivative licensing techniques that can be enforced other than share count include creating a derivative license with respect to limiting relative access to a work, such as a derivative license that prohibits “modify,” or “create derivative works” options. Other derivative licensing includes reducing the playback duration of the DRM content, or prohibiting burning, printing, or emailing of the DRM content so transferred. Further examples include enabling the purchase of further or renewal rights for the transferred content. Another derivative licensing regime might prevent the ability to sample from the designated content. For images, another derivative licensing rule might limit image transform operations to positive benefits, such as “red eye reduction” or “glare reduction” but not any arbitrary image transform. In essence, any mapping between an operation O and allowing that operation O can be enforced according to a derivative license created by a target device in accordance with the invention.

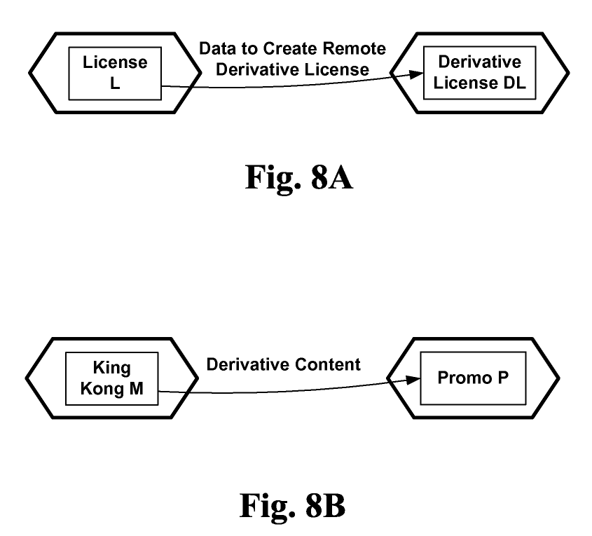

In addition, as shown in FIG. 8B, derivative content can also be supported for sharing content in accordance with the invention. For instance, as shown, a movie M, e.g., “King Kong,” could be shared with a friend's device, but the friends' device would only be able to play derivative content, such as a promo P for movie M. A link to purchase the movie could also be provided. In the share count example, a user having movie M would be able to share the promo P X times, e.g., 10 times, before the user is unable to share the promo P anymore. Thus, it is noted that any or all of the derivative licensing techniques can be combined or permuted to provide a desired derivative licensing scenario for DRM protected content shared in a P2P environment.

As a further non-limiting scenario enabled by the DRM content licensing techniques of the invention for a P2P environment, an embodiment is described for limiting operation of malicious software on a device. For instance, content can be classified on a machine according to different threat levels. For instance, level 1000 software objects are those from off the Internet, level 2000 software objects are software objects that have been tested on the device, and so on. The derivative licensing techniques of the invention can thus be used to generate limited licenses for use of software objects across devices in a P2P environment, e.g., to prevent access to protected memory spaces, or otherwise limited to prevent harm on the device.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with content roaming in a P2P environment in accordance with the present invention. The present invention may apply to an environment with server computers and client computers deployed in a network environment or a distributed computing environment, having remote or local storage.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods for content roaming in a P2P environment in accordance with the invention.

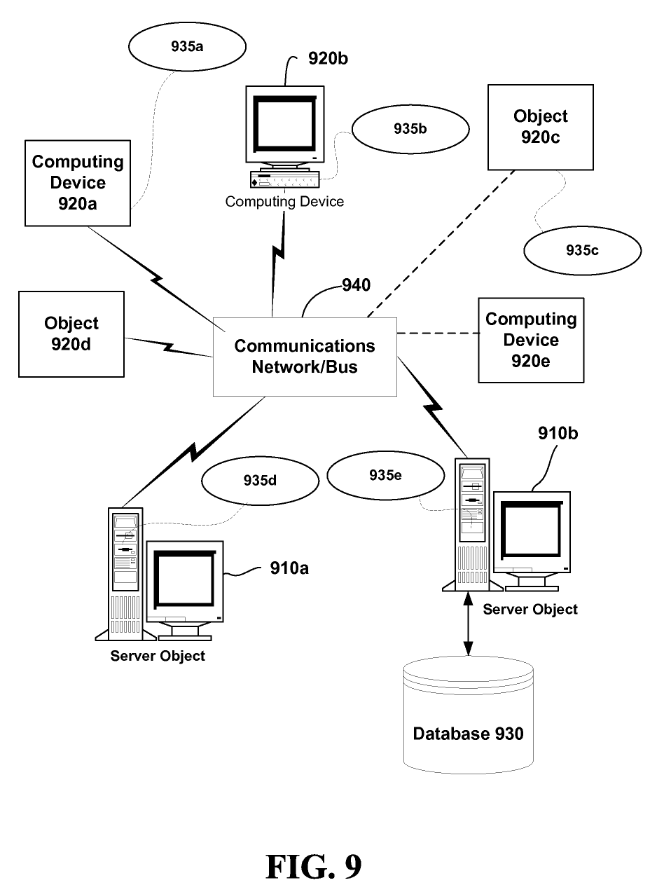

FIG. 9 provides a schematic diagram of an exemplary networked or distributed computing environment. The distributed computing environment comprises computing objects 910a, 910b, etc. and computing objects or devices 920a, 920b, 920c, 920d, 920e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 940. This network may itself comprise other computing objects and computing devices that provide services to the system of FIG. 9, and may itself represent multiple interconnected networks. In accordance with an aspect of the invention, each object 910a, 910b, etc. or 920a, 920b, 920c, 920d, 920e, etc. may contain an application that might make use of an API, or other object, software, firmware and/or hardware, suitable for use with the systems and methods for content roaming in a P2P environment in accordance with the invention.

It can also be appreciated that an object, such as 920c, may be hosted on another computing device 910a, 910b, etc. or 920a, 920b, 920c, 920d, 920e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to content roaming in a P2P environment according to the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present invention may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 9, as an example, computers 920a, 920b, 920c, 920d, 920e, etc. can be thought of as clients and computers 910a, 910b, etc. can be thought of as servers where servers 910a, 910b, etc. maintain the data that is then replicated to client computers 920a, 920b, 920c, 920d, 920e, etc., although any computer can be considered a client, a server, or both, depending on the circumstances. Any of these computing devices may be processing data or requesting services or tasks that may implicate the content roaming in a P2P environment in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for content roaming in a P2P environment of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 9 illustrates an exemplary networked or distributed environment, with server(s) in communication with client computer (s) via a network/bus, in which the present invention may be employed. In more detail, a number of servers 910a, 910b, etc. are interconnected via a communications network/bus 940, which may be a LAN, WAN, intranet, GSM network, the Internet, etc., with a number of client or remote computing devices 920a, 920b, 920c, 920d, 920e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to roam content across devices in a P2P environment.

In a network environment in which the communications network/bus 940 is the Internet, for example, the servers 910a, 910b, etc. can be Web servers with which the clients 920a, 920b, 920c, 920d, 920e, etc. communicate via any of a number of known protocols such as HTTP. Servers 910a, 910b, etc. may also serve as clients 920a, 920b, 920c, 920d, 920e, etc., as may be characteristic of a distributed computing environment.

As mentioned, communications may be wired or wireless, or a combination, where appropriate. Client devices 920a, 920b, 920c, 920d, 920e, etc. may or may not communicate via communications network/bus 14, and may have independent communications associated therewith. For example, in the case of a TV or VCR, there may or may not be a networked aspect to the control thereof. Each client computer 920a, 920b, 920c, 920d, 920e, etc. and server computer 910a, 910b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated. Any one or more of computers 910a, 910b, 920a, 920b, 920c, 920d, 920e, etc. may be responsible for the maintenance and updating of a database 930 or other storage element, such as a database or memory 930 for storing data processed or saved according to the invention. Thus, the present invention can be utilized in a computer network environment having client computers 920a, 920b, 920c, 920d, 920e, etc. that can access and interact with a computer network/bus 940 and server computers 910a, 910b, etc. that may interact with client computers 920a, 920b, 920c, 920d, 920e, etc. and other like devices, and databases 930.

### Exemplary Computing Device

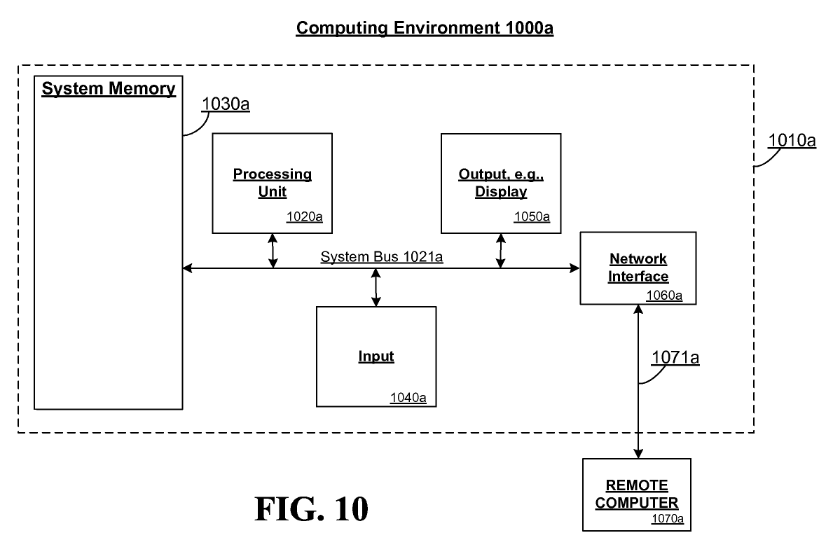

As mentioned, the invention applies to any device wherein it may be desirable to share DRM protected content in a P2P environment without involving a CLA. It should be understood, therefore, that handheld, portable and other computing devices and computing objects of all kinds are contemplated for use in connection with the present invention, i.e., anywhere that a device may include DRM protected content or otherwise receive, process or store data. Accordingly, the below general purpose remote computer described below in FIG. 10 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 10 thus illustrates an example of a suitable computing system environment 1000a in which the invention may be implemented, although as made clear above, the computing system environment 1000a is only one example of a suitable computing environment for a media device and is not intended to suggest any limitation as to the scope of use or functionality of the invention. Neither should the computing environment 1000a be interpreted as having any dependency or requirement relating to any one or combination of components illustrated in the exemplary operating environment 1000a.

With reference to FIG. 10, an exemplary remote device for implementing the invention includes a general purpose computing device in the form of a computer 1010a. Components of computer 1010a may include, but are not limited to, a processing unit 1020a, a system memory 1030a, and a system bus 1021a that couples various system components including the system memory to the processing unit 1020a. The system bus 1021a may be any of several types of bus structures including a memory bus or memory controller, a peripheral bus, and a local bus using any of a variety of bus architectures.

Computer 1010a typically includes a variety of computer readable media. Computer readable media can be any available media that can be accessed by computer 1010a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1010a. Communication media typically embodies computer readable instructions, data structures, program modules or other data in a modulated data signal such as a carrier wave or other transport mechanism and includes any information delivery media.

The system memory 1030a may include computer storage media in the form of volatile and/or nonvolatile memory such as read only memory (ROM) and/or random access memory (RAM). A basic input/output system (BIOS), containing the basic routines that help to transfer information between elements within computer 1010a, such as during start-up, may be stored in memory 1030a. Memory 1030a typically also contains data and/or program modules that are immediately accessible to and/or presently being operated on by processing unit 1020a. By way of example, and not limitation, memory 1030a may also include an operating system, application programs, other program modules, and program data.

The computer 1010a may also include other removable/non-removable, volatile/nonvolatile computer storage media. For example, computer 1010a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1021a through a non-removable memory interface such as an interface, and a magnetic disk drive or optical disk drive is typically connected to the system bus 1021a by a removable memory interface, such as an interface.

A user may enter commands and information into the computer 1010a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1020a through user input 1040a and associated interface(s) that are coupled to the system bus 1021a, but may be connected by other interface and bus structures, such as a parallel port, game port or a universal serial bus (USB). A graphics subsystem may also be connected to the system bus 1021a. A monitor or other type of display device is also connected to the system bus 1021a via an interface, such as output interface 1050a, which may in turn communicate with video memory. In addition to a monitor, computers may also include other peripheral output devices such as speakers and a printer, which may be connected through output interface 1050a.

The computer 1010a may operate in a networked or distributed environment using logical connections to one or more other remote computers, such as remote computer 1070a, which may in turn have media capabilities different from device 1010a. The remote computer 1070a may be a personal computer, a server, a router, a network PC, a peer device or other common network node, or any other remote media consumption or transmission device, and may include any or all of the elements described above relative to the computer 1010a. The logical connections depicted in FIG. 10 include a network 1071a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1010a is connected to the LAN 1071a through a network interface or adapter. When used in a WAN networking environment, the computer 1010a typically includes a communications component, such as a modem, or other means for establishing communications over the WAN, such as the Internet. A communications component, such as a modem, which may be internal or external, may be connected to the system bus 1021a via the user input interface of input 1040a, or other appropriate mechanism. In a networked environment, program modules depicted relative to the computer 1010a, or portions thereof, may be stored in a remote memory storage device. It will be appreciated that the network connections shown and described are exemplary and other means of establishing a communications link between the computers may be used.

There are multiple ways of implementing the present invention, e.g., an appropriate API, tool kit, driver code, operating system, control, standalone or downloadable software object, etc. which enables applications and services to use the systems and methods for content roaming in a P2P environment of the invention. The invention contemplates the use of the invention from the standpoint of an API (or other software object), as well as from a software or hardware object that shares or otherwise syncs DRM protected content in a P2P environment, or handles licensing generation or revocation in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to share DRM protected content in a P2P environment. For instance, the content roaming in a P2P environment of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the content roaming in a P2P environment of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of FIGS. 4, 6 and 7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide methods for content roaming in a P2P environment. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for roaming digital rights management (DRM) protected content across a plurality of peer-to-peer devices, comprising:
receiving DRM protected content including a local license at a first device of the plurality of peer-to-peer devices for restricting use of the DRM protected content at the first device according to a set of rights;
synchronizing the DRM protected content to a second device and enabling the second device to generate a remote license for the DRM protected content; and
reducing the set of rights of the local license in correspondence with a scope of the remote license generated by the second device.

2. The method of claim 1, wherein said receiving includes receiving the local license from a central licensing authority (CLA) or receiving the local license from memory of the first device.

3. The method of claim 1, wherein said synchronizing includes transferring the DRM protected content from the first device to the second device via a synchronization protocol including transmitting the DRM protected content as synchronization changes between the first device and second device according to the synchronization protocol.

4. The method of claim 1, wherein the enabling includes sending license data from the first device to the second device that enables the second device to generate the remote license.

5. The method of claim 1, wherein said receiving includes receiving DRM protected content including a local license having a share count that restricts the number of times that the DRM protected content can be shared.

6. The method of claim 1, wherein said reducing includes reducing a share count of the local license each time the DRM protected content is synchronized to another device of the plurality of peer-to-peer devices.

7. The method of claim 1, further comprising:
recapturing the set of rights in the local license that were reduced during said reducing step when the second device synchronizes the DRM protected content back to the first draft.

8. The method of claim 1, further comprising:
prohibiting recapturing the set of rights in the local license that were reduced during said reducing step.

9. A computer readable medium comprising computer executable instructions for carrying out the method of claim 1.

10. A first device of a plurality of peer-to-peer networked devices for receiving digital rights management (DRM) protected content from a second device of the plurality of peer-to-peer networked devices via synchronization changes received according to a synchronization protocol, comprising:
an interface for receiving the DRM protected content from the second device via the synchronization protocol including license data derived from a second license of the second device that defines second rights to the DRM protected content on the second device; and
a licensing component that generates a first license based on the license data that defines first rights to the DRM protected content on the first device whereby the second rights of the second license are reduced based on a difference between the second rights and the first rights.

11. The first device of claim 10, wherein the first license is a derivative license of the second license.

12. The first device of claim 11, wherein said first license maps to the second license via a predefined mapping from allowable first functionality with respect to the DRM protected content on the second device to allowable second functionality on the first device with respect to the DRM protected content synchronized to the first device.

13. The first device of claim 11, wherein said first license has a reduced share count compared to the second license, wherein each count of the share count allows the first device to share the DRM protected content with another device of the plurality of peer-to-peer devices a predetermined number of times defined by the share count.

14. The first device of claim 11, wherein said first license disallows at least one of modification of the DRM protected content or generation of derivative works from the DRM protected content on the first device wherein the second license allows said at least one of modification of the DRM protected content on the second device or generation of derivative works from the DRM protected content on the second device.

15. The first device of claim 11, wherein said first license includes rights to promotional content associated with the DRM protected content on the first device, and excludes rights to the full DRM protected content that are allowed on the second device.

16. The first device of claim 11, wherein said first license reduces a playback time of the DRM protected content on the first device relative to the corresponding playback time of the DRM protected content on the second device.

17. The first device of claim 11, wherein said first license prohibits initiating at least one of burning, printing or emailing of the DRM protected content from the first device whereas the second license allows said initiating of at least one of burning, printing or emailing of the DRM protected content from the second device.

18. The first device of claim 11, wherein said first license is a derivative license of the second license without designated rights in the first license that are present in the set of rights of the second license, wherein the first license includes a right to purchase one or more of the designated rights missing in the first license.

19. The first device of claim 11, wherein said first license for the synchronized DRM protected content expires prior to the second license, wherein the first license includes a right to renew the first license via a purchase.

20. The first device of claim 11, wherein the DRM protected content includes at least one image and said first license places limits on image transform operations that can be applied to the at least one image on the first device.

21. The first device of claim 11, wherein the DRM protected content includes at least one software object and said first license limits at least one operation that can be taken by the at least one software object to prevent harm to the first device by the at least one software object.

22. The first device of claim 21, wherein the first license prevents access of the at least one software object on the first device to a pre-defined portion of memory of the first device to prevent harm to the pre-defined portion of memory by the at least one software object.

23. The first device of claim 11, wherein the DRM protected content includes at least one software object and said first license limits at least one operation that can be applied to the at least one software object to prevent harm to the at least one software object on the first device.

24. The first device of claim 10, wherein the licensing component signs the first license, synchronizes the DRM protected content to a third device and transmits second license data to the third device enabling the third device to generate a third license for the DRM protected content for restricting use of the DRM protected content at the third device based on the first license of the first device.

25. A user interface for a device of a plurality of networked devices, wherein the device transfers or receives digital rights management (DRM) protected content to or from, respectively, any other device of the plurality of networked devices via a synchronization protocol, comprising:
a first user interface component for displaying at least one reception option for receiving a synchronization transfer of first DRM protected content and first license data from at least one other device of the plurality of networked devices; and
a licensing component that generates a first local license based on the first license data that defines first rights for interacting with the first DRM protected content from the device.

26. The user interface of claim 25, wherein the first rights of the first local license for interacting with the first DRM protected content are derived from rights associated with interacting with the first DRM protected content from the at least one other device that performs the synchronization transfer of the first DRM protected content to the device.

27. The user interface of claim 25, further including:
a second user interface component for displaying at least one transfer option for performing a synchronization transfer of second DRM protected content from the device to any other device of the plurality of networked devices via the synchronization protocol, wherein the transfer of the second DRM protected content also includes a transfer of second license data derived at least partly from a second local license associated with the second DRM protected content, and wherein the second license data includes sufficient information for the other device to generate a remote license that defines second rights for interacting with the second DRM protected content from the other device.

28. The user interface of claim 27, wherein the second local license associated with the second DRM protected content of the device enables the second DRM protected content to be shared with other devices of the plurality of networked devices at least one of (1) to be shared with more than one device, limited to devices of a single user, (2) to be shared with more than one device including devices of many users, (3) to be shared with exactly one first pre-defined device of the plurality of networked devices and/or (4) to be shared with exactly one second pre-defined device of the plurality of networked devices and to be further shared to multiple devices of the plurality of networked devices if such further sharing is limited to streaming the second DRM protected content of the device.
